(19) United States
(12) Patent Application Publication
(10) Pub. No.: US 2026/0073281 A1
(43) Pub. Date: Mar. 12, 2026

(54) Method And System For Generating Pedestrian-Vehicle Interaction Data For Training An Autonomous Vehicle

(71) Applicants: DENSO International America, Inc., Southfield, MI (US); Carnegie Mellon University, Pittsburgh, PA (US)

(72) Inventors: Shawn HUNT, Bethel Park, PA (US); Rohan CHOUDHURY, Pittsburgh, PA (US); Kris KITANI, Pittsburgh, PA (US); Kenta Mukoya, Kariya-city (JP); Erica Weng, Pittsburgh, PA (US)

(73) Assignees: DENSO International America, Inc., Southfield, MI (US); Carnegie Mellon University, Pittsburgh, PA (US)

(21) Appl. No.: 18/829,746

(22) Filed: Sep. 10, 2024

(51) Int. Cl. G06N 20/00

(52) U.S. Cl. CPC G06N 20/00

(57) ABSTRACT

A method and system for generating virtual pedestrian-vehicle interaction data includes generating a virtual reality environment in virtual reality device, generating a scenario in the virtual reality environment, the scenario comprising virtual vehicle movements, displaying the scenario in a virtual reality device, storing virtual reality movements relative to the scenario, the virtual reality movements comprising at least a yaw movement, communicating the virtual vehicle movements to a simulator controller, communicating the virtual vehicle movements to the simulator controller, associating the virtual reality movements, the virtual vehicle movements and the scenario to form pedestrian-vehicle data, and training an autonomous vehicle system using the pedestrian-vehicle data.

### FIELD

The present disclosure relates to training an autonomous vehicle, and, more specifically, to generating pedestrian-vehicle interaction data for training an autonomous vehicle.

### BACKGROUND

This section provides background information related to the present disclosure which is not necessarily prior art.

Safe autonomous vehicles require precise, multi-modal trajectory prediction systems, especially in highly interactive environments with pedestrians. A major issue for such learning-based prediction or planning systems is the lack of data in complex and dangerous scenes, especially as data-hungry models like Transformers have become the standard. Collecting data from scenes is challenging from public roads. Public datasets in particular lack the complex scenarios. Structured data collection, in which human subjects carry out long-tail behaviors, can be dangerous. For example, asking children to jaywalk across a busy road is unsafe.

Several methods have been proposed to collect synthetic data using virtual environments to compensate for this gap. For example, one method proposes a real-time simulator with a steering controller to acquire driving data in interactive scenarios. Another proposes collecting behavior and trajectory data of pedestrians using a keyboard controller. These methods pre-define interactive scenes of vehicles and pedestrians in the simulator to generate datasets. However, these systems suffer from a large sim-to-real gap as the subject uses a keyboard controller or joystick to control pedestrians while watching the screen. These controllers cannot accurately reproduce walking behaviors because of the restriction of control freedom. For example, behaviors like waiting for the right time to jaywalk while watching for oncoming vehicles are difficult to reproduce with such input devices due to a lack of head-yaw angle data. Body tracking with virtual reality (VR) has been proposed to solve this issue. Since VR headsets have an immersive 360-degree field of view, tracking the headset allows the collection of head rotation and yaw data. Prior systems and methods relate to a trajectory prediction for autonomous driving, datasets for training/test trajectory prediction model, and autonomous driving simulators for simulating vehicle-pedestrian interaction.

Modern trajectory forecasting models are deep, data-driven prediction models that predict futures for multiple interacting vehicles and pedestrians. Some popular trajectory forecasting methods from recent years include methods built on deep generative architectures, conditional variational autoencoders (CVAEs), hierarchical architectures, and transformers.

Though there is much variety among architectures, one commonality they all share is that they rely on training on ample amounts of good quality data to produce accurate prediction results.

Public datasets such as nuScenes, the Waymo Open Motion Dataset, Argoverse, and KITTI are often used for training and testing of trajectory prediction models. The datasets are collected in the real world by real vehicles driving in public traffic environments. These datasets are dominated by commonly-occurring environments and scenes; there is little variety in available scenes, and there is a particular lack of uncommon environments such as narrow roads or alleyways, and uncommon scenarios such as pedestrian jaywalking, pedestrians walking along side vehicles on the road, or dangerous or close contacts between pedestrians and vehicles. One method that is used to supplement real datasets is with more data from uncommon scenes is by generating synthetic data using traffic and pedestrian simulators. With simulators, it is possible to generate data in many scenarios with low cost. However, in terms of collecting the pedestrian behavior data, most synthetic dataset generation methods use rudimentary autonomous policies to generate pedestrian agent behavior. Other methods solicit input from real pedestrians via data-collection participants using mouse clicks or keyboard controls to control a pedestrian avatar in a virtual environment shown on a display screen. These methods also have limitations, as clicks and keyboard controls fall short of the full degree of control pedestrians have over their movements and trajectories during navigation in real urban experiences.

Using scenario simulators with VR headsets have been proposed to collect pedestrian behavior data more accurate than that found in autonomous simulators or to study pedestrian responses to vehicle motion. For example, VR simulators have been proposed where pedestrians are asked to click a button when they decide to cross the street in VR. Another system creates VR driving simulators to record driver trajectory data.

However, the known systems focus only on verifying pedestrian behavior.

### SUMMARY

This section provides a general summary of the disclosure, and is not a comprehensive disclosure of its full scope or all of its features.

In the present disclosure, a human-in-the-loop pedestrian VR simulator for autonomous driving which can replicate real pedestrian behaviors and interactions called JaywalkerVR based on CARLA, an open source simulator for autonomous vehicle research. A large, high-quality dataset of vehicle-pedestrian interactions called CARLA-VR is generated. The data is used for training several prediction models. A significant improvement, especially in highly interactive scenes, was found.

In one aspect of the disclosure, a method for generating virtual pedestrian-vehicle interaction data includes generating a virtual reality environment in a virtual reality device, generating a scenario in the virtual reality environment, the scenario comprising virtual vehicle movements, displaying the scenario in a virtual reality device, storing virtual reality movements relative to the scenario, the virtual reality movements comprising at least a yaw movement, communicating the virtual vehicle movements to a simulator controller, communicating the virtual vehicle movements to the simulator controller, associating the virtual reality movements, the virtual vehicle movements and the scenario to form pedestrian-vehicle data, and training an autonomous vehicle system using the pedestrian-vehicle data.

In another aspect of the disclosure, a virtual reality device programmed to display a virtual reality environment and a scenario in the virtual reality environment, the scenario comprising virtual vehicle movements, the virtual reality device sensing movements and communicating virtual reality movements, a simulator controller receiving the virtual reality movements and storing virtual reality movements relative to the scenario, the virtual reality movements comprising at least a yaw movement, the simulator controller receiving the virtual vehicle movements, associating the virtual reality movements, the virtual vehicle movements and the scenario to form pedestrian-vehicle data and an autonomous vehicle training system training an autonomous vehicle system using the pedestrian-vehicle data.

To summarize, a number of contributions have been obtained. A virtual reality-based autonomous driving simulator, JaywalkerVR, can realistically simulate vehicle-pedestrian interaction in long-tail scenarios. Aa high-quality vehicle-pedestrian interaction dataset, CARLA-VR, is obtained from real human subjects using the VR simulator of the present disclosure is obtained.

Experimental results supporting the benefit of the CARLA-VR dataset for improving trajectory prediction performance in long-tail pedestrian-vehicle interaction scenarios are set forth below.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagrammatic view of the pedestrian-vehicle interaction data collection system.

FIG. 2 is a block diagrammatic view of the simulator controller of FIG. 1.

FIG. 3 is a block diagrammatic view of the vehicle operator of FIG. 1.

FIG. 4 is a block diagrammatic view of the base station of FIG. 1.

FIG. 5 is a block diagrammatic view of the virtual reality device of FIG. 1.

FIG. 6 is a diagrammatic view of the sensor motions according to the present disclosure.

FIG. 7 is a block diagrammatic view of the autonomous vehicle training system of FIG. 1.

FIG. 8 is a representation of a virtual reality environment with a pedestrian and a vehicle.

FIG. 9A is a diagrammatic view of a jaywalking scenario.

FIG. 9B is a diagrammatic view of a parked car scenario.

FIG. 9C is a diagrammatic view of a four way stop scenario.

FIG. 9D is a diagrammatic view of a parking lot entrance scenario.

FIG. 10 is a high level flowchart of the method for operating the system.

FIG. 11 is a flowchart of a method for coordinating the operation of the real pedestrian and the virtual pedestrian.

FIG. 12 is a detailed flowchart of a method for communicating data from a skeletal model in the virtual environment.

FIG. 13 is a flowchart of a method for collecting data for the vehicle agent assets.

FIG. 14 is a table showing a comparison of values of the present data set in comparison to other data sets.

FIG. 15 is a diagrammatic visualization plot of different view of the system.

Corresponding reference numerals indicate corresponding parts throughout the several views of the drawings.

### DETAILED DESCRIPTION

Example embodiments will now be described more fully with reference to the accompanying drawings.

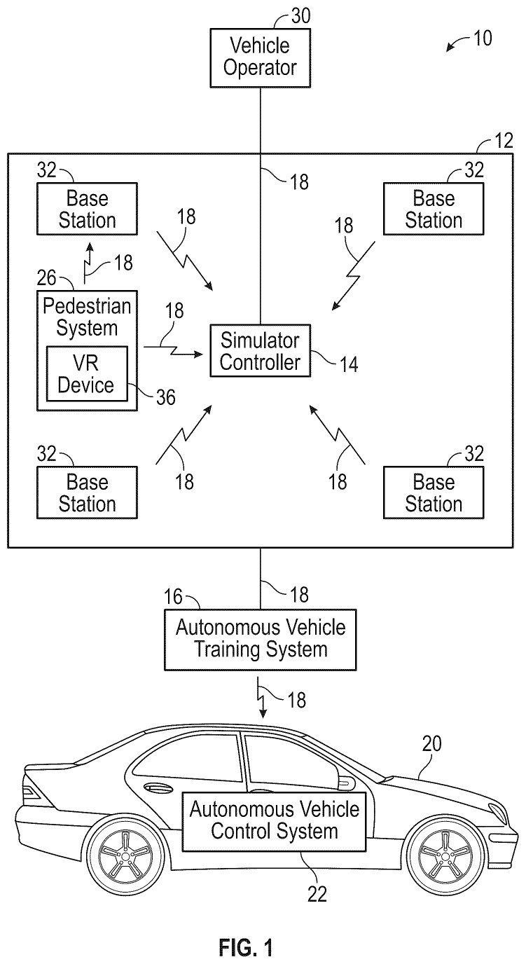

Referring now to FIG. 1, a system 10 used for collecting virtual reality data for pedestrian-vehicle interactions and using the pedestrian-vehicle interaction data to control an autonomous vehicle is set forth. The system includes a data collection environment that has a simulator controller set forth therein. The simulator controller controls the virtual reality system and ultimately collects pedestrian-vehicle interaction data that is communicated to an autonomous vehicle training system 16 through a network 18. The pedestrian-vehicle interaction data is pedestrian data and vehicle agent data of vehicles within the virtual environment that are time synchronized over a period of time during a scenario. The autonomous vehicle training system ultimately communicates training data to a vehicle 20 and more specifically to an autonomous vehicle control system 22. Ultimately, training of a neural network, as described below, may be used as the autonomous vehicle control system 22. The autonomous vehicle control system 22 may be “programmed” during manufacture of the vehicle. The data collection environment 12 may be a room or other area that allows for movement of a pedestrian associated with a pedestrian system 26. The pedestrian system 26 is virtual reality based and is attached to an actual human to record the reactions provided by the simulator controller 14 to different scenarios. The pedestrian system 26 may comprise a virtual reality headset as described in greater detail below. Ultimately, the signals from the virtually reality headset are communicated to the simulator controller 14 where they are stored therein. Ultimately, a vehicle operator 30 is in communication with the simulator controller 14. The vehicle operator 30 may be an artificial intelligence(AI) operator or an actual operator that steers a vehicle within the simulation. The actual operator may be a steering wheel sensor that generated a steering wheel angle single based on input from an operator. Different scenarios may use different operators. Ultimately, the signals from vehicle operator 30 are communicated to the simulator controller 14 where along with the scenario data form pedestrian-vehicle interaction data.

Base stations 32 may also be located within the simulator controller 14. In this example, four base stations 32 are used. However, a plurality of different base stations may be used depending on the size of the data collection environment 12 and various factors. The base stations 32 may be used to collect data from the pedestrian system and communicate the data to the simulator controller 14. The base stations32 may be used to triangulate the relative position of the pedestrian (the VR device 36 below) relative to the data collection environment.

The network 18 is used for intercommunicating data between the various components. The network 18 may be one or a combination of several different types of networks including both a wired network or a wireless network. The communication from the pedestrian system 26 may be wireless to allow the wearer of the pedestrian system 26 to experience a full unencumbered range of movement.

The pedestrian system 26 may include virtual reality (VR) device 36 that may be a head mounted display (HMD). The VR device 36 generates signals that correspond to the position of the pedestrian system 26 within the data collection environment 12. Also, the pedestrian system 26 at the VR device 36 includes pedestrian movement signals that correspond to the various positions of the pedestrian including the yaw or rotational movement of the head as described in greater detail below.

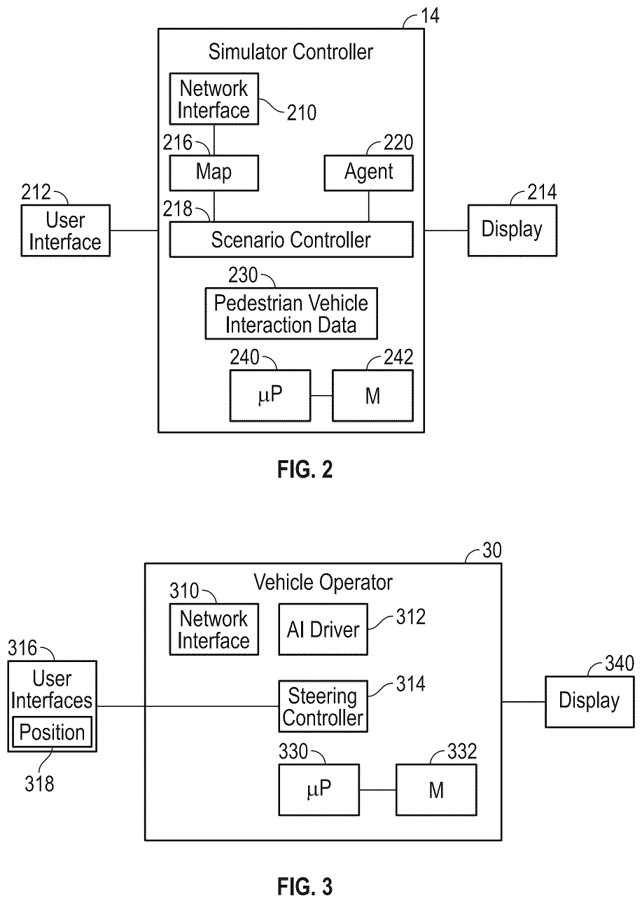

Referring now to FIG. 2, the simulator controller 14 is illustrated in further detail. The simulator controller 14 may comprise a network interface 210 for transmitting and receiving data through the network 18 illustrated in FIG. 1. The simulator controller may be associated with a user interface 212, such as keyboard, mouse, digital pen, touchscreen or types of user interfaces. The simulator controller 14 may also be associated with a display 214. The display may be used for displaying various scenarios, including the scenario, the pedestrian structure or, skeleton or avatar associated with the pedestrian system 26 described above.

The simulator controller 14 includes a map 216 that is associated with the scenarios 218. The scenarios 218 also are associated with an agent 220. The agent 220 defines the scenarios 218. As described in greater detail below, four scenarios were performed in the present disclosure including jaywalking, parked cars, a four way stop and a parking lot entrance. However, the agent 220 may be used to define various numbers of scenarios.

Ultimately, the simulator controller 14 generates pedestrian-vehicle interaction data 230. The pedestrian-vehicle interaction data includes data that corresponds to the scenario and the movement of the vehicles and the pedestrian within the scenario. The pedestrian-vehicle interaction data is pedestrian data and vehicle agent data of vehicles within the virtual environment that are time synchronized over a period of time during a scenario. The pedestrian-vehicle interaction data is ultimately used to train an autonomous vehicle system.

The agent 220 may allow a number of vehicles to interact with the map 216 in accordance with the scenario.

The simulator controller 14 may include a microprocessor 240 and a memory 242 associated therewith. The microprocessor 240 may act to control the various scenarios and the recording of data. The microprocessor 240 may also include instructions for forming the pedestrian-vehicle interaction data used in the training of an autonomous vehicle as described in greater detail below. The memory 242 may be a non-transitory computer-readable medium including machine-readable instructions that are executable by the processor.

Referring now to FIG. 3, the vehicle operator 30 may also include a network interface 310. The network interface may allow communication to and from the vehicle operator 30 through the network 18. The network interface 310 transmits data to and receives data from the simulator controller 14 illustrated in FIGS. 1 and 2. The vehicle operator 30 may be located within the data collection environment 12 or outside. The vehicle operator may be automated or manual as well. An artificial intelligence driver 312 may be used to move the vehicles within the scenario. The data associated with the vehicle movement may be referred to as virtual vehicle movements and are recorded relative to the scenario. The virtual vehicle movements may be communicated through the network interface 310. The scenario may include several vehicles, all of which may be controlled by the artificial intelligence driver 312.

The vehicle operator 30 may also include a steering controller 314 that records steering movement data signals from sensors of a user interface 316. The user interface 316 may be manually controlled by an operator. The user interfaces 316 may be joysticks or steering wheels that simulate movement for the vehicles within the scenario with a position sensor. A plurality of user interfaces 316 may be used to control each of the vehicles within the scenario. The user interface 316 has a position sensor 318 that generates signals used to control the virtual vehicles or assets. The position sensor 318 generates a signal of the relative position of the user interface such as an angle signal for a simulated steering wheel user interface.

The vehicle operator 30 may include a microprocessor 330 and a memory 332 associated therewith. The microprocessor 330 and the memory 332 are used for storing intermediate data and programming for performing relative to the scenario. The memory 332 may include a non-transitory computer-readable medium including machine-readable instructions that are executable by the processor. In an autonomous mode, the AI driver may operate the vehicle in a certain manner according to the scenario. For a manually operated user interface 316, operators may control the user interfaces based upon feedback from a display 340.

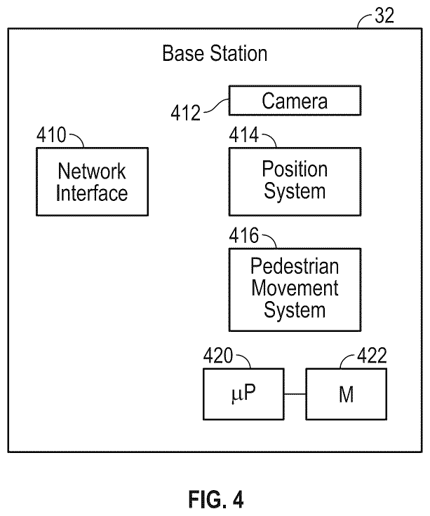

Referring now to FIG. 4, the base station 32 is illustrated in further detail. The base station 32 includes a network interface 410 that is in communication with the simulator controller 14 through the network 18. The network interface 410 may therefore be a wireless network interface. The base station 32 includes a camera 412 that is associated with a position system 414. The camera 412 and the position system 414 may be used to determine the pedestrian position relative to the base station 32 and the other base stations associated therewith. The position system 414 may therefore find the relative position of the pedestrian within a pedestrian movement system 416 may also be included within the base station to obtain the signals from the pedestrian system. That is, individual sensors may provide individual signals to the pedestrian movement system so that they may be transmitted to the simulator controller 14. The pedestrian movement system may include the various signals as described below including the yaw motion of the virtual reality device. The yaw movement corresponds to the rotational movement of the head relative to the other portions of the body of the pedestrian. A microprocessor 420 and a memory 422 may be provided in the system. The microprocessor 420 may be referred to as a processor and is used to execute instructions for the base station 32. The memory 422 may be a non-transitory computer-readable medium that includes machine-readable instructions that are executable by the processor 420 to perform the base station operating instructions.

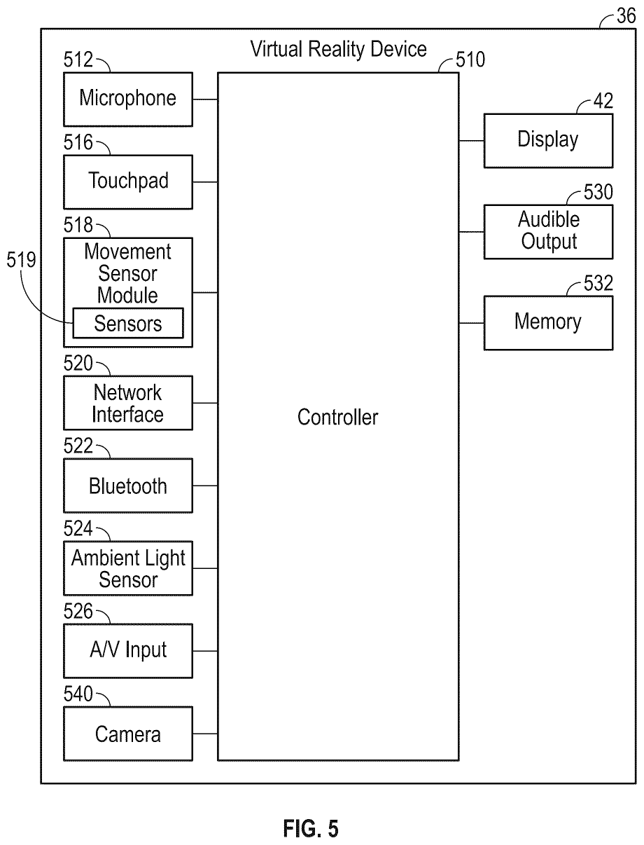

Referring now to FIG. 5, a block diagrammatic view of virtual reality device 36 is set forth. The virtual reality device 36 may include a microphone 512 that receives audible signals and converts the audible signals into electrical signals. A touchpad 516 provides digital signals corresponding to the touch of a hand or finger. The touchpad 516 may sense the movement of a finger or other user input. The virtual reality device 36 may also include a movement sensor module 518 that provides signals corresponding to movement of the device. Physical movement of the device may also correspond to an input. The movement sensor module 518 may include sensors 519, such as accelerometers, moment sensors, optical/eye motion detection sensors, and/or other sensors that generate signals allowing a device to determine relative movement and orientation of the device and/or movement of eyeballs of a user (referred to as gaze tracking). The movement sensor module 518 may also include a magnetometer. Sensor data provided by the various sensors 519 may be used to select determine the movement of the pedestrian in the scenario which may be translated into the virtual scenario. The touchpad 516 and the sensors 519 provide input and/or feedback from a user for the selection of offered/shown items and provide commands for changing a shown field of view (FOV).

The virtual reality device 36 may also include a network interface 520. The network interface 520 provides input and output signals to a wireless network, such as the internet. The network interface 520 may also communicate with a cellular system.

A Bluetooth® module 522 may send and receive Bluetooth® formatted signals to and from the controller 510 and communicate the signals externally to the virtual reality device 36. Bluetooth® may be one way to receive audio signals or video signals from the simulator controller 14.

An ambient light sensor 524 generates a signal corresponding to the ambient light levels around the virtual reality device 36. The ambient light sensor 524 generates a digital signal that corresponds to the amount of ambient light around the virtual reality device 36 and adjusts the brightness level in response thereto.

An A/V input 526 may receive the audio signals and the video signals from the simulator controller 14. In particular, the A/V input 526 may be a wired or wireless connection to the scenario controller 218 of the simulator controller 14.

The controller 510 may also be in communication with the display 42, an audio output 530 and a memory 532. The audible output 530 may generate an audible signal through a speaker or other device. Beeps and buzzers to provide the user with feedback may be generated. The memory 532 may be used to store various types of information including a user identifier, a user profile, a user location and user preferences. Of course, other operating parameters may also be stored within the memory 532.

A camera module 540 may generate camera signals corresponding to the environment in front of the actual pedestrian subject. The camera module 540 may communicate the camera signals to the simulator controller directly or through the VR device 36.

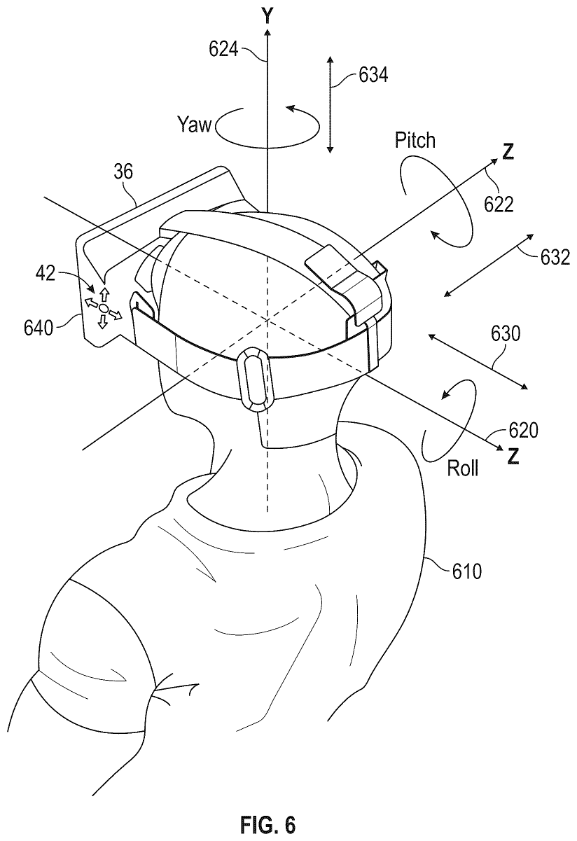

Referring now to FIG. 6, the movement sensors 518 of FIG. 5 may be used to measure various parameters of movement. A user 610 has the virtual reality device 36 coupled thereto. The moments around a roll axis 620, a pitch axis 622 and a yaw axis 624 are illustrated. Accelerations in the roll direction 630, the pitch direction 632 and the yaw direction 634 are measured by sensors within the virtual reality device 36. The sensors may be incorporated into the movement sensor module 518, the output of which is communicated to the client device 34 for use within the virtual reality module 456. An example touchpad 638 is shown on the side of the virtual reality device 36.

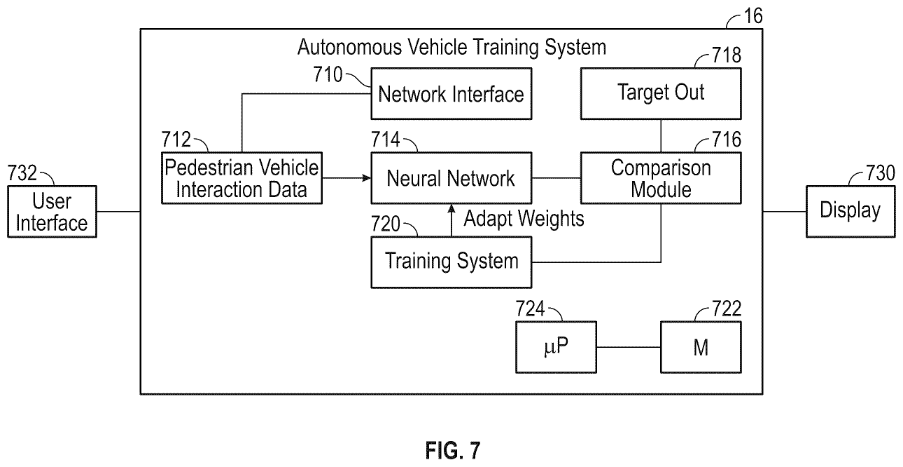

Referring now to FIG. 7, the autonomous vehicle training system 16 is illustrated in further detail. The autonomous vehicle training system 16 has a network interface 710 that is used to communicate with the network 18 as described above. The autonomous vehicle training system receives pedestrian vehicle interaction data 712 that is communicated from the simulator controller 14. The pedestrian-vehicle interaction data is communicated to a neural network 714 that is trained using the pedestrian-vehicle interaction data 712. The neural network 714 receives the pedestrian-vehicle interaction data and a comparison module is used to compare a target 718 with the output of the neural network 716. The training system 720 may be used to adapt the weights within the neural network based on the comparison of the target output 718 and the output of the neural network. That is, the pedestrian-vehicle interaction data is used to train the neural network to adapt the weights therein. Ultimately, the weights for the neural network may be stored within a memory 722 associated with the microprocessor 724. The memory 722 may also be used to perform the training steps. The memory 722 may be a non-transitory computer-readable medium that includes machine-readable instructions that are executable by the processor to perform the training. A display 730 may also be associated with the autonomous vehicle training system. The display 730 may allow the user through the user interface 732 to provide instruction to the training system.

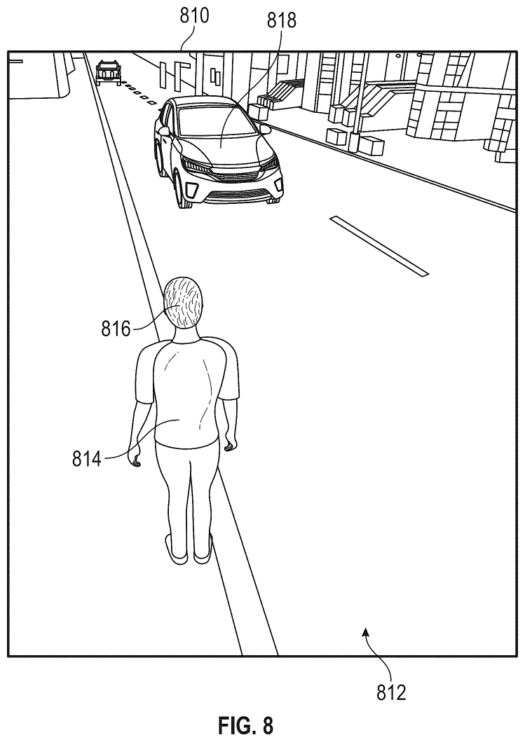

Referring now to FIG. 8, an example of a screen display 810 displayed in the virtual reality device 36 displaying a virtual reality environment 812 is set forth. In this example, a skeleton model 814 is provided as an avatar within the virtual reality environment 812 of the screen display 810. A virtual reality vehicle 818 is also provided in the virtual reality environment 812. The present example provides an example of a jaywalk scenario. The skeleton model 814 may have a head 816 that moves corresponding to the movement of the virtual reality device 36 and the yaw signals therefrom. Other motions corresponding to the VR device may also be provided. The relative movement of the virtual reality device 36 relative to the base stations may provide translational movement relative to the data collection environment 12. Movement within the data collection environment 12 may therefore be translated into movement within the virtual reality screen display 810. From a user perspective, the person wearing the VR device 36 may not see the skeleton model 814 or avatar but rather may see the virtual vehicle 818 from the perspective of the skeleton model 814 or avatar.

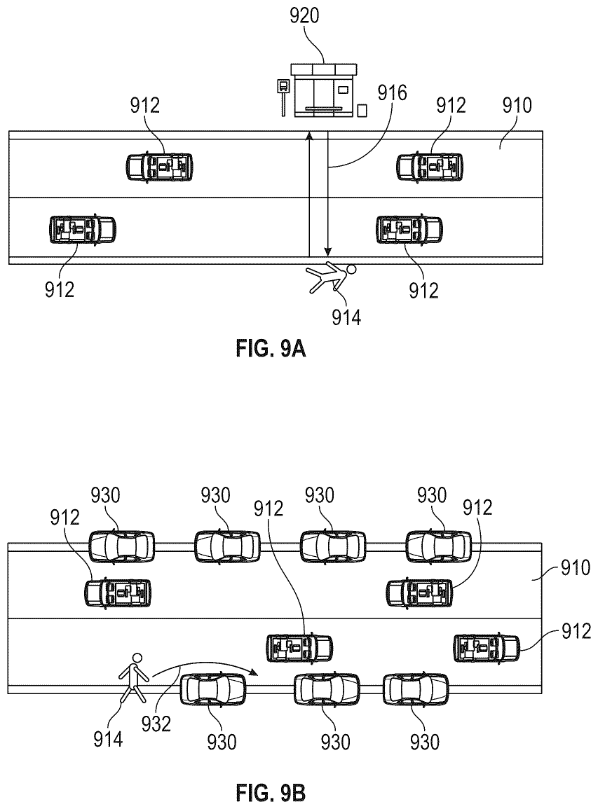

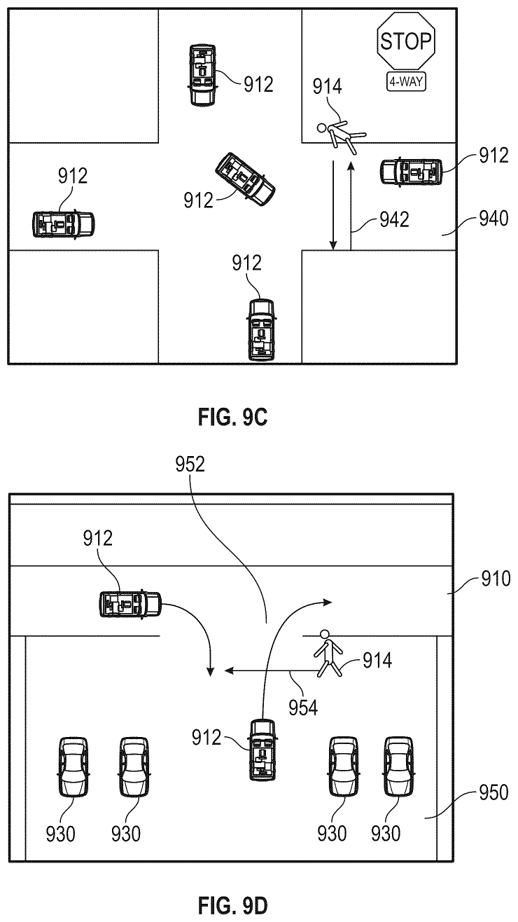

Referring now to FIG. 9A, a representation of a jaywalking scenario is illustrated. A road 910 is illustrated having a plurality of vehicles 912. The vehicles 912 may be controlled by the vehicle operator 30. The vehicles may be controlled in an autonomous fashion or be controlled manually by receiving inputs from a user interface 316 such as that illustrated above in FIG. 3. In this example, a representation of a pedestrian 914 is illustrated and the desired path 916 is also illustrated. During the scenario, the vehicles 912 are controlled to operate on the road 910 in various ways. The pedestrian 914 attempts to cross the road to get to the building 920. Pedestrian 914 jaywalks across a road while yielding to vehicles coming from both directions on a two-lane road. In this scenario, the pedestrians 914 to try to interact with oncoming vehicles, such as yielding to vehicles 912. The pedestrians cross the street on their own timing and with their own decision-making. For example, some subjects behave aggressively, but others will behave nervously and miss the opportunity to walk. Then, a variety of behaviors is determined in each subject, such as different speeds of walking and different timings of crossing. The positions of the vehicles are recorded as data. Also, the position of the pedestrian 914 as sensed through the virtual reality device and the base stations is also determined. In this manner, pedestrian-vehicle interaction data is performed. The data may be sampled at various rates including 20 Hz so that it may later be used for training of a neural network.

Referring now to FIG. 9B, the road 910 is illustrated again in a parked car scenario. In the parked car scenario, a plurality of parked vehicles 930 are used and are fixed at the side of the road 910. In this example, the pedestrian 914 travels onto the surface of the road around one of the parked vehicles 930. Pedestrian 914 walks along the edge of the road, avoiding parked vehicles and moving to a position one car ahead while paying attention to vehicles approaching from behind. In this scenario, it is expected that the subjects to start walking on their own timing.

The other vehicles 912 are moving vehicles and are controlled by the vehicle operator. The pedestrian 914 is to travel on the road 910 in the path 932 around one of the parked vehicles 930.

Referring now to FIG. 9C, a four way stop 940 is illustrated. In this example, the pedestrian 914 is to travel along the path 942. The four way stop illustrates a plurality of vehicles 912 that are controlled by the vehicle operator 30. The path 942 corresponds to a crosswalk and the pedestrian 914 is to avoid the vehicles 912. Each pedestrians 914 crosses the crosswalk while paying attention to cars coming from four directions at a four-way stop. In this scenario, subjects are expected to cross at the crosswalk at various times as decided by each of them for vehicles coming at them from different directions. The data of the pedestrian position and vehicle agent positions are communicated to the simulator controller.

Referring now to FIG. 9D, a parking lot entrance scenario is illustrated. In this example, the road 910 is illustrated with a parking lot 850 adjacent thereto. The parking lot 950 has an entrance 952 across which the pedestrian 914 is to traverse along the path 954. In this example, the pedestrian 914 is to avoid vehicles on the road 910 entering the parking lot 950 and avoid vehicles leaving the parking lot 950 and entering the road 910. That is, pedestrians walk through the entrance to a parking lot while paying attention to and avoiding any entering and exiting vehicles. In this scenario, we expect subjects to behave by yielding or not yielding to the vehicles at various decisions.

In all these scenarios set forth in FIGS. 9A-9D, virtual vehicle movements are stored together with virtual reality movements for the virtual reality pedestrian device. Ultimately, the virtual reality movements are generated from sensors in the virtual reality device (virtual reality movement signs) and the virtual vehicle movements are stored relative to the scenario so that data may be used for training a neural network. The data from many different subjects and different scenarios is recorded to allow training of the devices. In the present examples, four scenarios are illustrated. However, other scenarios may be obtained using the teachings set forth herein.

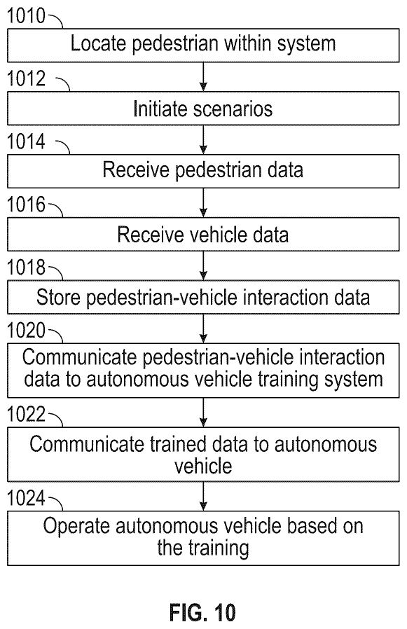

Referring now to FIG. 10, a high level block diagrammatic view of the operation of the system 10 is set forth. In step 1010, the pedestrian is located within the system 10. That is, the pedestrian system 26 is located within the data collection environment 12 of FIG. 1. In step 1012, scenarios are initiated at the simulator controller 14. By initiating scenarios in step 1012, the pedestrian or skeleton model 814 is to attempt one of the scenarios. At the same time, the vehicles are controlled by the vehicle operator 30 by driving on the road, stopping at the four way stop or traversing from a parking lot entrance to a road or vice versa. Ultimately, pedestrian data is received at step 1014. The pedestrian data provides relative data within the data collection environment. That is, the relative position and the movements from the virtual reality device are stored in a memory. Likewise, vehicle data is received in step 1016. The received vehicle data corresponds to each of the vehicles in the scenario. In step 1018, the pedestrian-vehicle interaction data is stored. The pedestrian-vehicle interaction data is stored relative to the scenario and the data of the scenario. The scenario data becomes part of the pedestrian-vehicle interaction data.

In step 1020, the pedestrian-vehicle interaction data is communicated to an autonomous vehicle training system. The autonomous vehicle training system obtains a plurality of different pedestrian-vehicle interaction datasets from a number of different users and a number of different scenarios. In step 1022, the trained data is communicated to an autonomous vehicle. In a production setting, each vehicle has chips with the predetermined weights from the neural network trained prior to assembly and installed within the vehicle. In step 1024, the autonomous vehicle is operated based on the training. That is, the autonomous vehicle has a plurality of sensors that provide inputs to the autonomous vehicle control system 22 illustrated in FIG. 1. Based on the training, autonomous vehicles may provide various types of maneuvers.

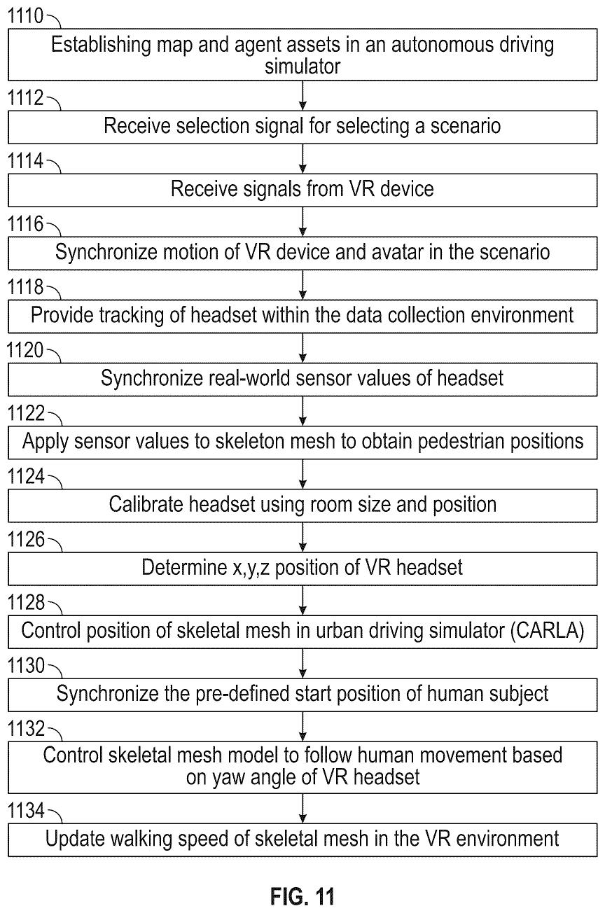

Referring now to FIG. 11, a method of operating a VR human-in-the-loop pedestrian simulator based on CARLA is set forth. CARLA is a popular open-source driving simulator for autonomous driving based on Unreal Engine 4. In the Unreal Engine 4, a map and agent assets are established for defining scenarios. Maps are provided with roadways, parking lots, four way stops or other driving locations. Agent assets include moving vehicles acting within the maps and parked vehicles. In step 1112 a selection signal is received from a user interface to select a scenario.

In step 1114, signals are received from the VR device 36, which may be referred to as a headset. The VR device allows human subjects to interact with agent assets as realistically as possible. Annotated interaction data is determined between vehicles and pedestrians, especially pedestrian trajectory and head rotation data. The system simulates the walker avatar's motion according to actual human motion. In step 1116 the motion between the real human and pedestrian avatars in the simulation world is synchronized. In step 1118 the tracking information from the VR device such as 3D location and rotation angle are provided.

The tracking function of the VR device controls the pedestrian avatar. This function uses the HTC BaseStation 2.0, an “Outside-In” tracking system which employs a lighthouse tracking method to accurately determine the position of the headset within the tracking range. The official tracking range extends up to approximately 10 meters in both dimensions in the present example.

In step 1120, the real-world sensor values of the headset are synchronized and in step 1122 the sensor values are applied to the entire skeleton mesh to obtain pedestrian positions. In step 1124 the VR device is calibrated using the room size and position. Using this information, the SteamVR plugin in Unreal Engine is used to obtain the 3D position [x, y, z] of VR device in the data collection environment in step 1126. In step 1128 the position is used to control the position of the pedestrian skeletal mesh in the virtual environment, CARLA in this example. In each scenario, the pre-defined start position of the pedestrian avatar with the standing position of the human subject in step 1130, and in step 1132 the skeletal mesh model is controlled to follow the real human's movement. The yaw angle is used to adjust the yaw angle of the whole skeleton mesh. The other VR sensors are also used to update the position. In step 1134, the pedestrian's movement animation or avatar is used to match the actual walking speed, enabling a person wearing a VR headset to control and move the avatar freely within the VR environment.

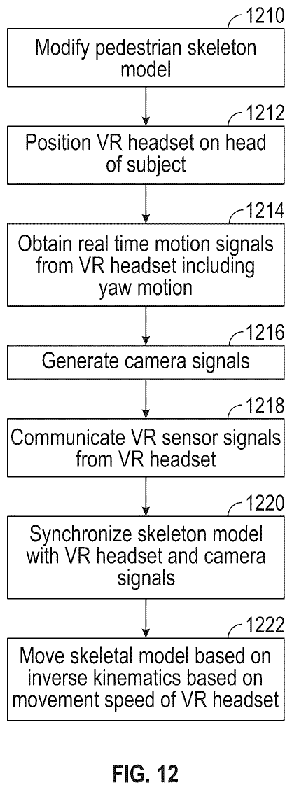

Referring now to FIG. 12, the walker skeleton model is provided in CARLA by default, and the movement of this skeleton model can be controlled by keyboard or joystick input devices. However, there are no native functions that control that skeleton model according to the movement of a VR headset. In step 1210 the walker blueprint is modified to control the skeleton model by synchronizing it with the motion of the VR headset. In step 1212 the headset is positioned on the headset of the subject. Sensor signals corresponding to the real-time motion of the VR headset are obtained in step 1214. The virtual camera module is attached to the walker's head and camera signals are generated in step 1216. The camera module 540 acts as the avatar's virtual eyes, and the skeletal mesh defines the walker's appearance. The VR device communicates signals from the sensors and camera to the simulator controller 14 in step 1218. In step 1220, the walker's blueprint or skeletal model is modified in order to get a first-person feel in. In step 1222 the skeletal model is moved based on the speed of VR device. An IK setup (inverse kinematics) is used for the representation of walking animation of the skeleton. The skeleton model is designed to make walking motions in response to the movement speed and of the VR device. That is, both the movement such as the yaw movement and the relative position and speed of the skeletal model in the VR world are synchronized.

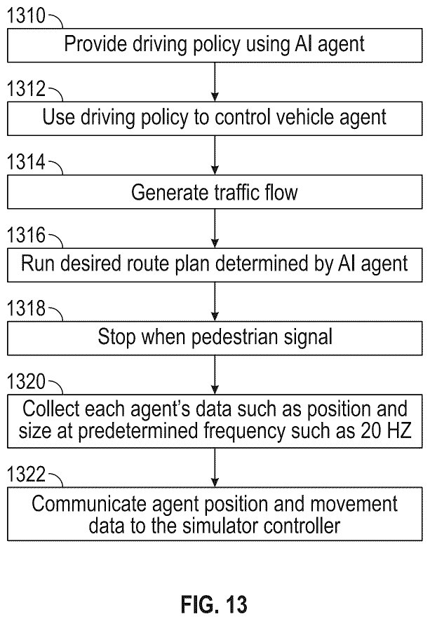

Referring now to FIG. 13, in order to define arbitrary scenarios for data collection, a scenario generation function using a CARLA Python API, in particular, the TrafficManager components. First, in step 1310, the CARLA AI Agent, which is the driving policy for autopilot implemented in the CARLA standard is provided. The CARLA AI agent is used to control the vehicle agent of CARLA in step 1312, and the traffic flow was generated after the Autopilot function was enabled in each spawned vehicle in step 1314. In terms of route planning, desired routes automatically are run according to the route plan determined by the AI Agent by creating a route plan in which vehicle spawn points are arranged in step 1316. In addition, the behavior of the AI Agent is used with the default setting and stops in step 1318 when a pedestrian is detected. Also, each agent's movement data, such as position, size, and speed are collected at 20 Hz in step 1320. In step 1322 the movement data of the agents are communicated to the simulator controller.

By way of example only, the constructed system used HTC Vive Pro 2 VR headset which has SteamVR support. Four HTC BaseStation 2.0 units were used for tracking the headset. The VIVE Wireless adapter allows the headset to be used completely wirelessly. A desktop PC which contains a PCI express slot which was used to install the image emitter module of the VIVE Wireless adapter for the simulator, with an Intel core i9-12900KF CPU, NVIDIA GeForce RTX 3080 GPU, and 64 GB RAM. Since VIVE Wireless is only supported by Windows 10 or 11, the CARLA-based VR pedestrian simulator was placed onto a Windows 11 desktop PC. Unreal Engine UE 4.26.2 and CARLA 0.9.13 were also used.

Data was collected from 80 participants in each of the four scenarios. In the Jaywalk, Parked Cars and 4-Way Stop scenarios, the surrounding vehicles were controlled by a CARLA AI agent and in completely autonomous driving mode. In the Parking Lot Entrance scenario, the vehicles are controlled by a human driver using a steering controller, as CARLA did not support implementing a route plan for the vehicle to enter and exit the parking lot. Data from a total of 572 scenes comprising 12702 frames. The data for both the virtual vehicles and the virtual pedestrians contains position [x, y, z][m], three-dimensional rotation angles [θ, φ, ψ][deg], velocity [vx, vy, vz][m/s], acceleration [ax, ay, az][m/s2] in global coordinates in CARLA's map, object type (car, pedestrian) and object shape information [length, width, height]. Each scene data is between 10 and 30 s long and was recorded at 20 Hz.

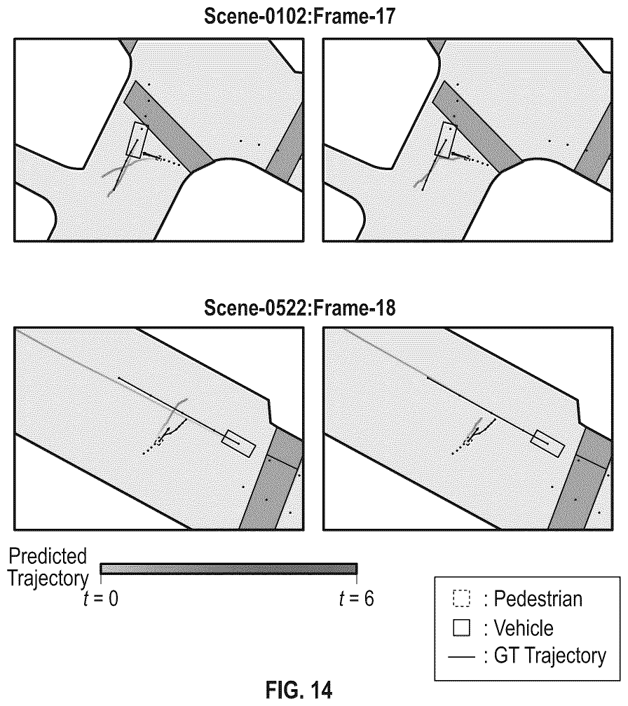

Referring now to FIG. 14, AgentFormer was used in experiments for measuring trajectory forecasting performance. AgentFormer is a Transformer-based model that jointly models the time and social dimensions with an agent-aware attention mechanism. The model leverages a sequence representation of multi-agent trajectories by flattening trajectory features across time and agents and using the resulting spatiotemporal attention-based features for trajectory prediction. Ten sample 2D trajectories for each agent generated using past trajectories, yaw angle information, and a semantic segmentation image of a bird's eye view obtained from CARLA as inputs. Different datasets were used in our experiments The dataset called nuScenes is a widely used public autonomous driving dataset with annotated data, such as position in global coordinates in nuScenes's map, rotation, and bounding box size at 2 Hz. nuScenes also provides HD semantic maps with 11 semantic classes. A nuScenes prediction dataset from annotated data for the nuScenes prediction challenge was used. This is used for pre-training of the trajectory prediction model and also for evaluation of prediction performance in the general scenes.

To check the prediction model's performance in rare scenes, interactive scenes from similar situations to our simulation scenarios (e.g. jaywalking) from annotated data on the nuScenes dataset. Since this dataset contains only vehicle-pedestrian interaction data that actually occurred in the real world, testing the prediction model with this dataset allows evaluation of the model's performance in real-world interactive scenes. This dataset is used for the evaluation of prediction performance in interactive scenes in the real world.

The collected CARLA-VR dataset contains rare vehicle-pedestrian interactive scene data from the VR simulator. It is used for pre-training of the trajectory prediction model and also for evaluation of prediction performance in the interactive scenes in the simulator world. To align the sampling rate, CARLA-VR dataset is also resampled from 20 Hz to 2 Hz. The baseline is state-of-the-art AgentFormer trained on the nuScenes prediction dataset, denoted AgentFormer-

To demonstrate the utility of the proposed dataset, AgentFormer-B was trained on CARLA-VR to get AgentFormer-VR. The performance of both models' based on nuScenes-prediction, CARLA-VR interaction, and nuScenes-interaction was evaluated. The following metrics to measure performance.

Marginal XDE encompasses Marginal Average Displacement Error (ADE) and Marginal Final Displacement Error (FDE), and these are commonly used for evaluating how the predicted trajectory is close to ground truth(GT) trajectory. Since AgentFormer generates 10 sample trajectory sets, the minimum error minXDE, the top-K minimum error is evaluated. Joint XDE was also used. Unlike XDE, Joint XDE(JXDE) evaluates scene-level ADE/FDE. Since these metrics calculate the average error over all agents within a sample before selecting the best one, agents between different samples are not mixed-and-matched. This means how close the prediction result (top-K sample) to GT trajectory with considering social-interaction at scene-level may be evaluated. Same as XDE, minJXDE (top-K minimum error) was evaluated.

Collision Rate (CR) evaluates whether the predicted trajectories of each agent collide with each other within the same prediction timestep.

In FIG. 14, the results of the experiments are listed. In terms of the evaluation result of CARLA-VR dataset and nuScenes interaction dataset, all metrics improve when incorporating our CARLA-VR dataset. Marginal XDE performance improves by 10.7-12.8%, and Joint XDE also improves by 12.6-16.9%. Further, the most important metric for safety-collision rate-improves by 4.9%.

FIG. 15 shows predicted trajectories from AgentFormer-B (left) and AgentFormer-VR (right). The GT trajectories are illustrated, and the best predicted trajectories are shown with time-varying shading. We find that AgentFormer-B, only trained on nuScenes prediction dataset, often predicts trajectories for pedestrians that lead them into direct collision with vehicles. We attribute this to the rarity of dangerous pedestrian-vehicle interactions in the real-world nuScenes dataset. On the other hand, when AgentFormer leverages our safety-critical interaction dataset, we see in the right figure that the pedestrian is predicted to yield to the incoming vehicle, better matching the ground truth trajectory. These qualitative visualizations corroborate our quantitative results that the proposed CARLA-VR dataset, containing safety-critical pedestrian-vehicle interactions, better enables trajectory prediction models to model agent behavior in dangerous and rare scenarios.

The results show that the prediction model becomes more robust in real-world interactive scenes through fine-tuning on the CARLA-VR dataset. In particular, minJXDE and CR decreases substantially for nuScenes-interaction. The most safety-critical and difficult scenarios in the nuScenes dataset. Furthermore, AgentFormer-VR improves collision rates across all datasets. This is particularly crucial in evaluating trajectory forecasting models, as the ability to predict plausible trajectories with minimal collisions is important for autonomous driving applications. While performance in the minJXDE metric drops for the nuScenes-prediction test set, the full nuScenes dataset mostly consists of common or simpler driving scenarios, and that evaluation on the more complex and interactive driving subset, nuScenes-interaction, is more critical. For these more safety-critical and dynamic scenarios, leveraging the CARLA-VR dataset substantially improves the robustness of interaction-aware motion predictions.

The system of the present disclosure, JaywalkerVR, is a human-in-the-loop VR pedestrian simulator enabling the collection of realistic long-tail vehicle-pedestrian interaction scenario data. A new CARLA-VR dataset, which contains rich, interactive vehicle-pedestrian scenario data from actual humans is also presented. In particular, the use of VR in data collection enables accurate trajectory and head angle annotations. Finally, the effectiveness of this dataset for training trajectory forecasting models was shown. Fine-tuning on the CARLA-VR dataset improved XDE, JXDE and CR, especially in highly interactive scenes. The experiments show that our dataset and data collection pipeline will be effective tools for developing more robust prediction algorithms moving forward.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method comprising:
generating a virtual reality environment in virtual reality device;
generating a scenario in the virtual reality environment, the scenario comprising virtual vehicle movements;
displaying the scenario in a virtual reality device;
storing virtual reality movements relative to the scenario, the virtual reality movements comprising at least a yaw movement;
communicating the virtual vehicle movements to a simulator controller;
communicating the virtual vehicle movements to the simulator controller;
associating the virtual reality movements, the virtual vehicle movements and the scenario to form pedestrian-vehicle data; and
training an autonomous vehicle system using the pedestrian-vehicle data.

2. The method of claim 1 wherein the virtual reality movements comprise a pedestrian movement based on virtual reality device movements.

3. The method of claim 1 wherein the virtual reality movements comprise virtual reality movements within a data collection environment.

4. The method of claim 1 wherein the virtual reality movements comprise virtual reality movement relative to a data collection environment.

5. The method of claim 1 wherein the virtual reality movements comprise position, rotation and velocity.

6. The method of claim 1 wherein position is determined from a plurality of base stations in a data collection environment.

7. The method of claim 1 wherein the virtual reality movements comprise position, rotation, velocity and acceleration.

8. The method of claim 1 wherein the virtual vehicle movements comprise position, rotation and velocity and object shape data.

9. The method of claim 8 wherein the object shape data comprises length, width and height.

10. The method of claim 1 wherein the virtual vehicle movements comprise position, rotation, velocity, three-dimensional rotation, location and rotation angle.

11. The method of claim 1 wherein prior to communicating the virtual vehicle movement, controlling virtual vehicle movements with an artificial intelligence operator.

12. The method of claim 1 wherein prior to communicating the virtual vehicle movement, controlling virtual vehicle movements based on signals from a steering wheel user interface.

13. A system comprising:
a virtual reality device programmed to display a virtual reality environment and a scenario in the virtual reality environment, the scenario comprising virtual vehicle movements, the virtual reality device sensing movements and communicating virtual reality movements;
a simulator controller receiving the virtual reality movements and storing virtual reality movements relative to the scenario, said virtual reality movements comprising at least a yaw movement, the simulator controller receiving the virtual vehicle movements, associating the virtual reality movements, the virtual vehicle movements and the scenario to form pedestrian-vehicle data; and
an autonomous vehicle training system training an autonomous vehicle system using the pedestrian-vehicle data.

14. The system of claim 13 wherein the virtual reality movements comprise a pedestrian movement based on the virtual reality device movements.

15. The system of claim 13 wherein the virtual reality movements comprise virtual reality movements within a data collection environment.

16. The system of claim 13 wherein the virtual reality movements comprise position, rotation and velocity.

17. The system of claim 13 wherein the virtual reality movements comprise position, rotation, velocity and acceleration.

18. The system of claim 13 wherein the virtual vehicle movements comprise position, rotation and velocity and object shape data.

19. The system of claim 13 wherein the virtual vehicle movements comprise position, rotation, velocity, three-dimensional rotation, location and rotation angle.

20. The system of claim 13 further comprising an artificial intelligence operator controlling the virtual vehicle movements.
